(19) United States
(12) Patent Application Publication
(10) Pub. No.: US 2026/0048460 A1
(43) Pub. Date: Feb. 19, 2026

(54) INDEX TOOLING ASSEMBLY

(71) Applicant: The Boeing Company, Arlington, VA (US)

(72) Inventor: Chester James Hill, IV, Grafton, IL (US)

(73) Assignee: The Boeing Company, Arlington, VA (US)

(21) Appl. No.: 18/808,556

(22) Filed: Aug. 19, 2024

(51) Int. Cl. B23Q 1/44

(52) U.S. Cl. CPC B23Q 1/44

(57) ABSTRACT

An index tooling assembly for supporting a component during a manufacturing process includes a stationary support, a bracket fixed to the stationary support, and a locking assembly. A rail is fixed to the stationary support. The index tooling assembly includes an indexing assembly movably coupled to the rail to adjust a position of the indexing assembly. The indexing assembly includes at least one indexing feature configured to cooperate with a locating feature of the component. The locking assembly includes a post movably coupled to the bracket and a tongue supported via the post. The tongue is attachable to a clevis of the indexing assembly to move the indexing assembly linearly in response to movement of the post. The post is selectively locked in a final position to fix the indexing assembly in an initial position to prevent movement of the indexing assembly relative to the stationary support.

### BACKGROUND

Various manufacturing processes may be implemented in the assembly of large-scale structural components. Some of these manufacturing processes require that the initial assembly of numerous structural components are held in a nominal orientation. Tooling indexes may be used to hold the assembly in the nominal orientation. Generally, friction-based clamps may be used to hold the individual components of the assembly in place, but the clamps may shift and/or apply loads that induce distortion into the assembly.

### SUMMARY

Therefore, it is desirable to develop an index tooling assembly that is adjustable to accommodate variations within one or more components that are to be positioned relative to an assembly for installation thereon, without imparting distortion into the assembly.

The present disclosure provides an index tooling assembly for supporting a component during a manufacturing process. The component includes a locating feature. The index tooling assembly includes a stationary support, a bracket fixed to the stationary support, and a locking assembly. The index tooling assembly also includes a rail spaced from the bracket and fixed to the stationary support. The index tooling assembly further includes an indexing assembly movably coupled to the rail to adjust a position of the indexing assembly relative to the stationary support. The indexing assembly includes at least one indexing feature configured to cooperate with the locating feature of the component. The indexing assembly also includes a clevis. The locking assembly includes a post movably coupled to the bracket and a tongue supported via the post. The tongue is attachable to the clevis to move the indexing assembly linearly in response to movement of the post. The post is selectively locked in a final position to fix the indexing assembly in an initial position to prevent movement of the indexing assembly relative to the stationary support.

The present disclosure provides another index tooling assembly for supporting a component during a manufacturing process. The component includes a locating feature, and a stationary support has a bracket and a rail fixed thereto. The index tooling assembly includes an indexing assembly and a locking assembly. The indexing assembly is configured to move linearly along the rail to adjust a position of the indexing assembly relative to the stationary support. The indexing assembly includes at least one indexing feature configured to cooperate with the locating feature of the component. The indexing assembly includes a clevis. The locking assembly includes a post movably coupled to the bracket and a tongue supported via the post. The tongue is attachable to the clevis to move the indexing assembly linearly in response to movement of the post. The post is selectively locked in a final position to fix the indexing assembly in an initial position to prevent movement of the indexing assembly relative to the stationary support.

The detailed description and the drawings or FIGS. are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic perspective view of an index tooling assembly having a locking assembly of a first configuration and a component shown in dash-dot-dot-dash lines coupled to an indexing assembly.

FIG. 2 is a schematic side view of the index tooling assembly of FIG. 1 with the component removed.

FIG. 3 is a schematic perspective fragmented view of a tongue and a clevis attached to each other via a connector.

FIG. 4 is a schematic perspective fragmented view of the tongue having an elongated opening.

FIG. 5 is a schematic perspective fragmented cross-sectional view of the index tooling assembly of FIG. 1.

FIG. 6 is a schematic enlarged cross-sectional view of thrust bearings and other features of FIG. 5.

FIG. 7 is a schematic perspective view of the index tooling assembly having a locking assembly of a second configuration.

FIG. 8 is a schematic perspective fragmented cross-sectional view of the locking assembly of FIG. 7.

FIG. 9 is a schematic perspective fragmented view of the locking assembly of FIGS. 7 and 8.

FIG. 10 is a schematic perspective fragmented view of the locking assembly of FIG. 9 with a bracket removed to more clearly show a clamp.

The present disclosure may be extended to modifications and alternative forms, with representative configurations shown by way of example in the drawings and described in detail below. Inventive aspects of the disclosure are not limited to the disclosed configurations. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader’s understanding, and do not represent limitations (for example, to the position, orientation, or use, etc.) on the scope of the disclosure, as defined by the appended claims. Moreover, terms such as "first," "second," "third," and so on, may be used to describe separate components. Such terminology may include the words specifically mentioned above, derivatives thereof, and words of similar import. Furthermore, the term “substantially” can refer to a slight imprecision or slight variance of a condition, quantity, value, or dimension, etc., some of which are within manufacturing variance or tolerance ranges.

As used herein, an element or step recited in the singular and preceded by the word “a” or “an” should be understood as not necessarily excluding the plural of the elements or steps. That is, “a”, “an”, “the”, “at least one”, and “one or more” are used interchangeably to indicate that at least one of the items is present and more than one may be present, unless stated otherwise. Further, any reference to “one configuration” is not intended to be interpreted as excluding the existence of additional configurations that also incorporate the recited features. Moreover, unless explicitly stated to the contrary, configurations “comprising” or “having” an element or a plurality of elements having a particular property may include additional elements not having that property. The phrase “at least one of” as used herein should be construed to include the non-exclusive logical “or”, i.e., A and/or B and so on depending on the number of components.

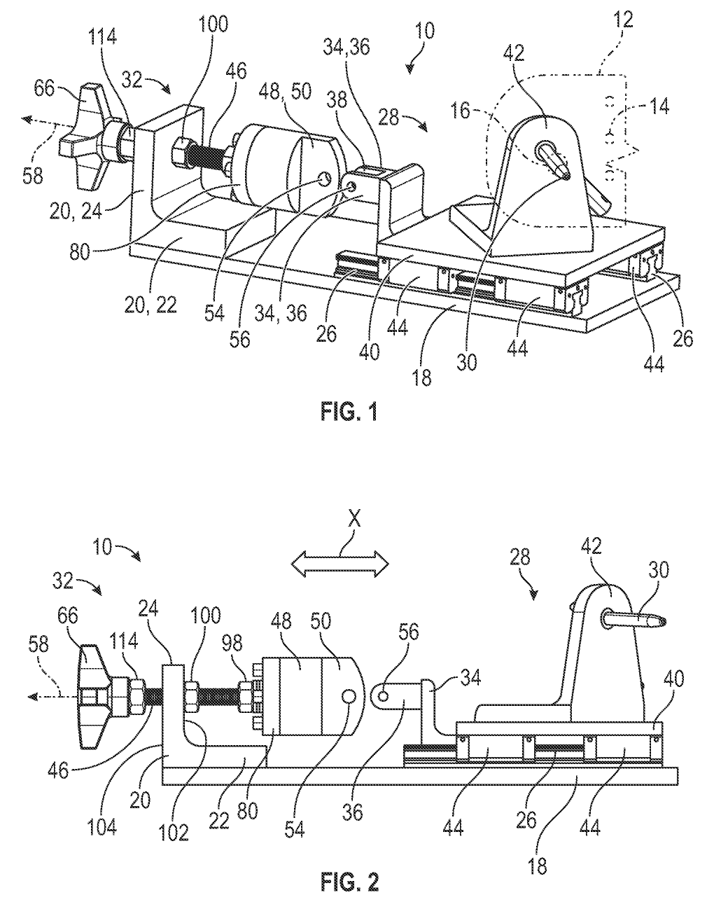

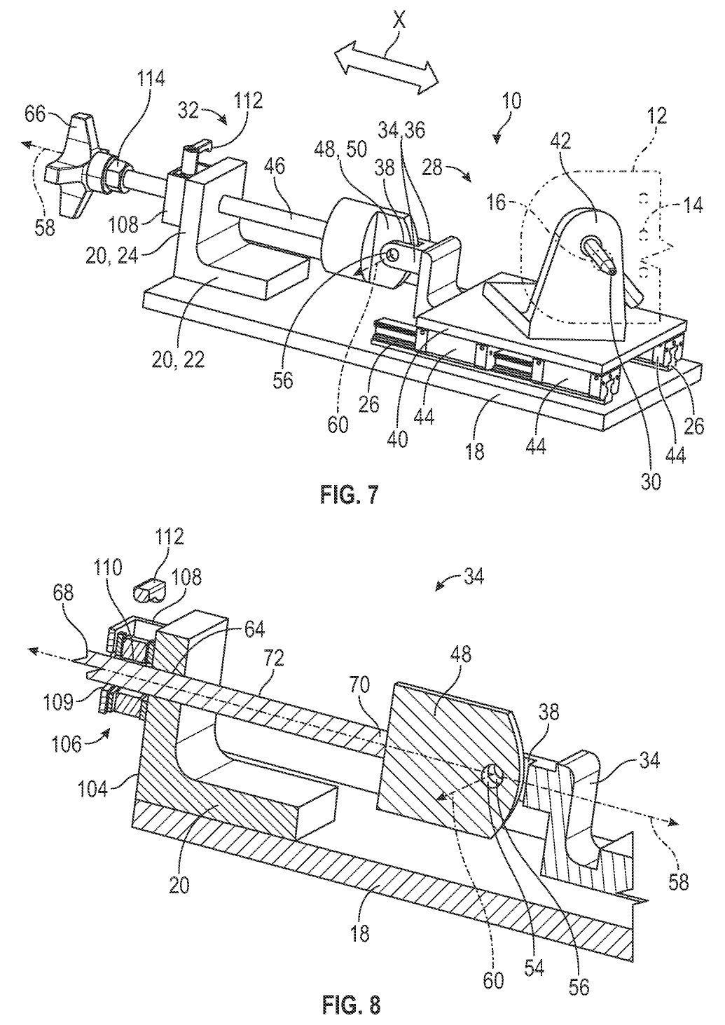

Referring to the figures, wherein like numerals indicate like or corresponding parts throughout the several views, an index tooling assembly 10 for supporting a component 12 during a manufacturing process is generally shown in FIGS. 1 and 7. Various manufacturing processes may require that one or more of the components 12 are held in a nominal orientation. Non-limiting examples of the manufacturing processes may include machining processes, finishing processes, attachment processes, or any other manufacturing processes that it is desirable to hold the component(s) 12 in the nominal orientation. As detailed further below, the index tooling assembly 10 is adjustable to accommodate variations within one or more of the components 12 that are to be positioned relative to an assembly for installation thereon, without imparting distortion into the assembly. The below discussion generally refers to the component 12, but it is to be appreciated that the below discussion applies any number of the components 12.

The component 12 defines a plurality of holes 14 of determinate size. That is, the component 12 is part of an assembly that has full size, i.e. determinate size, holes 14 that no additional drilling of the holes occurs in a later process. In other words, the holes 14 at this stage are drilled to the desired size, i.e., full size holes, that will not be further drilled at a later stage. As such, the component 12 is a fully machined engineered component 12.

The components 12 may be any suitable configuration, and non-limiting examples may include panels, skins, spars, ribs, or any other suitable configuration.

In certain situations, it may be desirable to perform various manufacturing processes to the component 12 after the holes 14 have been formed of the determinate size. For some of the manufacturing processes, it is desirable to align the component 12 in a predetermined orientation, such as the nominal orientation. Therefore, the component 12 may be coupled to the index tooling assembly 10 to perform the desired manufacturing process. To do so, the component 12 may be located relative to another point of reference. As such, the component 12 may include a locating feature 16 or a plurality of locating features 16 which is implemented to couple the component 12 to the index tooling assembly 10. The locating feature 16 of the component 12 is used to align the component 12 in the desired orientation relative to another point of reference.

The locating features 16 of one or more of the components 12 may be configured the same or one or more of the locating features 16 of one or more of the components 12 may be different than each other. For illustrative purposes, FIG. 1 illustrates the locating feature 16 of the component 12 as an aperture 16, but it is to be appreciated that the locating feature 16 of the component 12 may be a post, a pin, a surface of the component 12, etc. In certain configurations, one or more of the holes 14 may be used as the locating feature(s) 16.

Continuing with FIGS. 1 and 7, the index tooling assembly 10 includes a stationary support 18 and a bracket 20 fixed to the stationary support 18. Therefore, the bracket 20 acts as a fixture and remains stationary. The bracket 20 may include a base 22 fixed to the stationary support 18 and a flange 24 extending outwardly from the base 22 such that the flange 24 is spaced from the stationary support 18. In one non-limiting example, the bracket 20 may be an L-shaped configuration. It is to be appreciated that the bracket 20 may be any suitable configuration, and the figures are illustrative of one non-limiting example.

Continuing with FIGS. 1 and 7, the index tooling assembly 10 also includes a rail 26. Generally, the rail 26 is spaced from the bracket 20 and fixed to the stationary support 18. As such, the rail 26 remains stationary on the stationary support 18. The rail 26 may be any suitable configuration, and as non-limiting examples, the rail 26 may optionally be configured as a single rail 26 or a plurality of rails 26 spaced from each other. For illustrative purposes, the figures illustrate a plurality of rails 26 disposed substantially parallel to each other.

Continuing with FIGS. 1 and 7, the index tooling assembly 10 also includes an indexing assembly 28 movably coupled to the rail 26. That is, the indexing assembly 28 is movable, and thus adjustable, along the rail 26 relative to the bracket 20 and the stationary support 18. Generally, the indexing assembly 28 is movably coupled to the rail 26 to adjust a position of the indexing assembly 28 relative to the stationary support 18, and more specifically, the indexing assembly 28 is configured to move linearly along the rail 26 to adjust the position of the indexing assembly 28 relative to the stationary support 18. In certain configurations, the indexing assembly 28 is movable linearly relative to the stationary support 18. Therefore, the one or more rails 26 may be orientated on the stationary support 18 to allow the indexing assembly 28 to be movable linearly relative to the stationary support 18 and the bracket 20. The indexing assembly 28 may be movable/adjustable to accommodate different components 12 for the desired manufacturing process. Furthermore, the indexing assembly 28 may be movable/adjustable to provide the desired support and security of the different components 12 for the desired manufacturing process, without imparting distortion into the components 12.

The rail 26 may be any suitable configuration to allow the indexing assembly 28 to move along the rail 26. For example, as discussed above, the rail 26 may optionally be configured as a single rail 26 or a plurality of rails 26 spaced from each other in which the indexing assembly 28 rides across. As such, the rail 26 may include one or more bars, tracks, belts, rollers, wheels, conveyors, or any other suitable rail 26 to allow the indexing assembly 28 to move there along, or any other methods to permit linear or axial movement of the indexing assembly 28 along an axis.

Continuing with FIGS. 1 and 7, the indexing assembly 28 includes at least one indexing feature 30 configured to cooperate with the locating feature 16 of the component 12. Generally, the indexing feature 30 and the locating feature 16 are configured to cooperate with each other to provide a precision fit therebetween to minimize play or slop between the component 12 and the indexing assembly 28, which assists in preventing shifting of the components 12 and/or preventing distortions of the components 12. In other words, the indexing feature 30 and the locating feature 16 cooperate to assist in positioning the components 12 in the nominal orientation. The component 12 may be coupled to the index tooling assembly 10 via the indexing feature 30. That is, the locating feature 16 of the component 12 may be located relative to the other point of reference being the indexing feature 30. As such, one or more of the indexing features 30 may cooperate with one or more of the locating features 16 of the component 12 to align the component 12 in the desired orientation, such as the nominal orientation. The component 12 is located precisely via engagement of the locating feature 16 and the indexing feature 30.

If implementing more than one of the indexing features 30 of the indexing assembly 28, the indexing features 30 may be configured the same or one or more of the indexing features 30 may be different than each other. For illustrative purposes, FIG. 1 illustrates the indexing feature 30 of the indexing assembly 28 as a pin, a post, a dowel, etc., but it is to be appreciated that the indexing feature 30 of the component 12 may be an aperture, etc.

Continuing with FIGS. 1 and 7, the indexing tooling assembly also includes a locking assembly 32 selectively attached to the indexing assembly 28. Generally, when the indexing assembly 28 is attached to the locking assembly 32, the locking assembly 32 may be used to move the indexing assembly 28 to a desired position to locate the component 12, and additional, may be used to lock the indexing assembly 28 in the desired position. The locking assembly 32 of FIGS. 1 and 7 remain the desired position without shifting and without applying loads that may induce distortion into the components 12.

Continuing with FIGS. 1 and 7, the indexing assembly 28 also includes a clevis 34, and the clevis 34 is selectively attached to the locking assembly 32. When the clevis 34 is attached to the locking assembly 32, the locking assembly 32 may move and lock the indexing assembly 28 in the desired position. In certain configurations, the clevis 34 may include a pair of spaced apart prongs 36 to define a slot 38 between the prongs 36. It is to be appreciated that the clevis 34 may be any suitable configuration, and the figures illustrate one non-limiting example. For example, the clevis 34 may be a single prong 36 or more than two prongs 36, and other examples, the clevis 34 may be a hook, a clamp, a fastener, or any other suitable configuration.

Continuing with the indexing assembly 28, the indexing assembly 28 may also include a platform 40 (see FIGS. 1 and 7) having the clevis 34 and the at least one locating feature 16 attached thereto. Generally, the platform 40 supports the at least one locating feature 16. The locating feature 16 may be directly attached to or indirectly attached to the platform 40. For example, the indexing assembly 28 may optionally include a brace 42 supporting the locating feature 16. The brace 42 may be fixed to the platform 40. In certain configurations, the brace 42 may be configured as the indexing feature 30, such as the features as described above for the indexing feature 30, or the brace 30 may be configured with a face that indexes to a surface of the component 12.

The indexing assembly 28 may also include a footing 44 attached to the platform 40. Furthermore, the footing 44 is coupled to the rail 26 to allow the indexing assembly 28 to move along the rail 26. The footing 44 may optionally be configured as a single foot 44 or a plurality of feet 44 spaced from each other in which the foot 44 rides across the rail 26 or the feet 44 ride across the respective rails 26. As such, the footing 44 may include one or more structures (i.e., foot 44 or feet 44) that cooperate with the configuration of the rail 26 to allow the indexing assembly 28 to move relative to the stationary support 18.

As shown in FIGS. 1 and 7, generally, the footing 44 is complementary to the configuration of the rail 26 such that the indexing assembly 28 slides linearly on the footing 44 along the rail 26. FIGS. 1 and 7 illustrate the footing 44 as a plurality of feet 44 coupled to one rail 26 and another plurality of feet 44 coupled to another rail 26. The footing 44 (i.e., foot 44 and feet 44) may be elongated or any other suitable length. Generally, the footing 44 (i.e., foot 44 and feet 44) may be any suitable configuration that complements the rail(s) 26 to allow the indexing assembly 28 to move linearly along the rail(s) 26.

Referring to FIGS. 1, 5, 7, and 8, the locking assembly 32 includes a post 46 movably coupled to the bracket 20 and a tongue 48 supported via the post 46. The tongue 48 is attachable to the clevis 34 to move the indexing assembly 28 on the rail 26 in response to movement of the post 46, and more specifically, the tongue 48 is attachable to the clevis 34 to move the indexing assembly 28 linearly in response to movement of the post 46. Optionally, the tongue 48 may include a tang 50 extending outwardly toward the clevis 34.

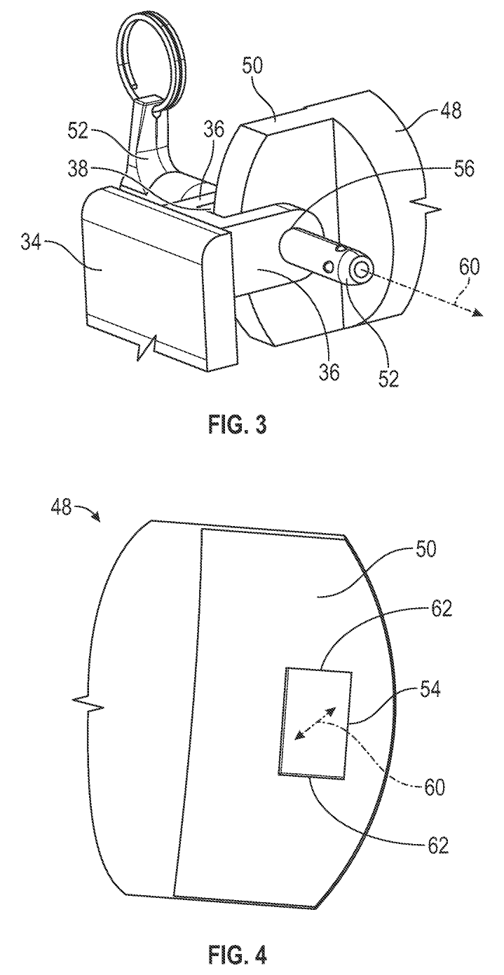

Generally, the locking assembly 32 may include a connector 52 (see FIG. 3) that engages the clevis 34 and the tongue 48 to attach together the indexing assembly 28 and the locking assembly 32. Once the connector 52 attaches together the tongue 48 and the clevis 34, the post 46 may adjust the position of the indexing assembly 28; that is, the indexing assembly 28 may be pushed or pulled linearly along the rail 26. When the connector 52 is detached from the tongue 48 and/or the clevis 34, the indexing assembly 28 may be movable independently of the locking assembly 32.

Referring to FIG. 3, the connector 52 may be disposed through respective openings 54, 56 of the clevis 34 and the tongue 48. Therefore, in certain configurations, the tongue 48 defines a first opening 54 and the clevis 34 defines a second opening 56, and the connector 52 is selectively disposed through the first opening 54 and the second opening 56 to attach together the tongue 48 and the clevis 34. The connector 52 may provide a precision fit through the openings 54, 56 to minimize play or slop between the clevis 34 and the tongue 48, which assists in preventing shifting of the components 12 and/or preventing distortions of the components 12. In other words, the connector 52 assists in positioning the components 12 in the nominal orientation when connecting the clevis 34 and the tongue 48 together. When the tongue 48 is configured with the tang 50, the tang 50 may define the first opening 54. When the clevis 34 is configured with the prongs 36, each of the prongs 36 may define the second opening 56.

The post 46 may be elongated relative to a central axis 58, and the post 46 may be any suitable configuration, and some non-limiting examples will be discussed further below. In addition, the connector 52 may be any suitable configuration, and non-limiting examples may include a post, a pin, a clip, a fastener, or any other structures to provide a precision fit through the openings 54, 56 to minimize play or slop between the clevis 34 and the tongue 48.

Referring to FIGS. 2, 4, and 8, the first opening 54 of the tongue 48 may be defined along a first axis 60 transverse to the central axis 58. In certain configurations, the first opening 54 is substantially perpendicular to the central axis 58. The first opening 54 may be any suitable configuration, and non-limiting examples are shown in FIGS. 2, 4, and 8. For example, the first opening 54 may be circular, oval, elongated, square, rectangular, or any other suitable configuration. Therefore, for illustrative purposes, the first opening 54 is illustrated as circular in FIGS. 2 and 8, but referring to FIG. 4, the first opening 54 is illustrated as elongated, and more specifically, the first opening 54 is elongated relative to opposing end 62 of the first opening 54 radially relative to the first axis 60 such that the first opening 54 forms an oblong orientation in a generally vertically, which causes the first opening 54 to be larger than the second opening 56. Referring to FIG. 4, the first opening 54 may be elongated generally vertically to allow play in the vertical directions to prevent binding when the connector 52 is being connected to the tongue 48 and the clevis 34.

Generally, movement of the post 46 in certain directions correspondingly moves the tongue 48. For example, the post 46 is movable linearly to correspondingly move the tongue 48 linearly. In certain configurations, the post 46 is movable in other directions independently of the tongue 48. That is, some movement of the post 46 may not be conveyed to the tongue 48, which will be discussed further below. Once the tongue 48 is attached to the clevis 34, this linear movement of the post 46 /tongue 48 is conveyed to the indexing assembly 28 as linear movement as well, due to the indexing assembly 28 being on the rails 26. Therefore, movement of the post 46 of the locking assembly 32 may pushed or pulled the indexing assembly 28. In certain configurations, the post 46 is movable linearly relative to the central axis 58, and thus, the tongue 48 is movable linearly relative to the central axis 58. The tongue 48 is attachable to the clevis 34 to move the indexing assembly 28 linearly in response to movement of the post 46. Therefore, for example, the indexing assembly 28 may be movable linearly relative to the rail 26 in a first direction and a second direction opposite the first direction in response to movement of the post 46 when the tongue 48 is attached to the clevis 34. In certain configurations, the first direction and the second direction are substantially parallel to the central axis 58. See arrow X in FIGS. 2 and 7, which is illustrative of the general directions for the first direction and the second direction.

Continuing with FIGS. 1, 5, 7, and 8, the post 46 is selectively locked in a final position to fix the indexing assembly 28 in an initial position to prevent movement of the indexing assembly 28 relative to the stationary support 18. That is, when the post 46 is locked in the final position, the indexing assembly 28 is correspondingly locked in the initial position (when the tongue 48 is attached to the clevis 34), which thus, fixes the component 12 in the nominal orientation via the indexing feature 30 /locating feature 16 for the desired manufacturing process.

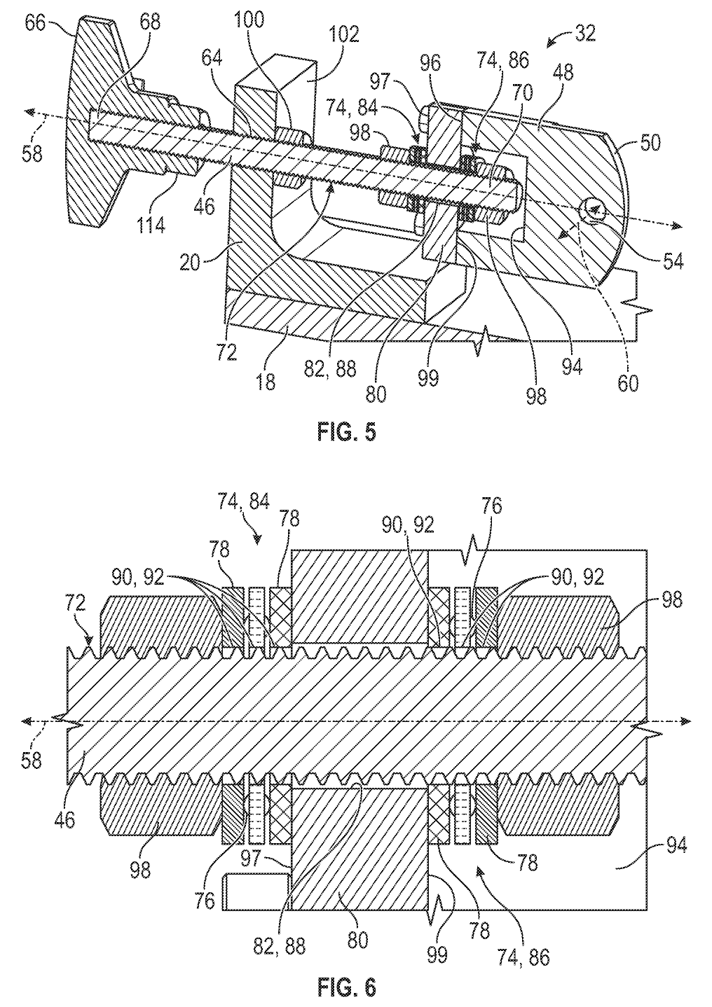

Referring to FIGS. 5 and 8, the bracket 20 may define an orifice 64 along the central axis 58. Generally, the post 46 is disposed through the orifice 64, and thus, the post 46 is movable relative to the bracket 20. Therefore, the bracket 20 remains stationary and the post 46 is movable. In certain configurations, the flange 24 of the bracket 20 defines the orifice 64, which spaces the post 46 away from the stationary support 18.

Referring to FIGS. 1 and 7, the locking assembly 32 may include a handle 66 attached to the post 46 to move the post 46 as desired. Generally, the flange 24 of the bracket 20 is disposed between the handle 66 and the tongue 48. Therefore, if the handle 66 is rotated about the central axis 58, the post 46 correspondingly rotates about the central axis 58, and if the handle 66 is pushed or pulled, the post 46 correspondingly moves linearly along the central axis 58. In certain configurations, the handle 66 is attached to a first end 68 of the post 46 and the tongue 48 is attached to a second end 70 of the post 46. Generally, the first end 68 and the second end 70 of the post 46 are spaced from each other. As best shown in FIGS. 5 and 8, the post 46 is supported via the bracket 20 between the first end 68 and the second end 70 of the post 46.

In certain configurations, the locking assembly 32 may utilize different features to accomplish the locking and unlocking of the post 46, and non-limiting examples of the different configurations are discussed below. As such, some of the features of the locking assembly 32 may be different from each other, as shown by comparing FIGS. 5 and 8. Furthermore, in certain configurations, to move the post 46 linearly, the configurations of FIGS. 5 and 8 accomplish the movement differently, which will also be discussed further below.

Referring to FIGS. 2 and 5, the post 46 in this configuration may be movable linearly, as well as rotatable. That is, the post 46 may be movable axially along the central axis 58 and may be rotatable relative to the central axis 58.

Continuing with FIGS. 2 and 5, the post 46 may be threaded, and in certain configurations, the post 46 may include an outer surface 72 defining the threads. Therefore, the post 46 may be threaded to the bracket 20 such that rotation of the post 46 about the central axis 58 causes linear movement of the tongue 48 relative to the central axis 58. In this configuration, the bracket 20 is threaded inside of the orifice 64, and the threaded post 46 cooperates with the threaded orifice 64. As such, rotation of the post 46 in one direction causes the post 46 to move linearly along the central axis 58 in the first direction, and rotation of the post 46 in the opposite direction causes the post 46 to move linearly along the central axis 58 in the second direction. In certain configurations, the entire length of the post 46 is threaded.

Referring to FIGS. 5 and 6, the locking assembly 32 may include a plurality of thrust bearings 74 disposed about the post 46 and coupled to the tongue 48 to minimize rotation of the tongue 48 when torque is applied to the thrust bearings 74 via rotation of the post 46 about the central axis 58. In other words, the thrust bearings 74 may be disposed between the post 46 and the tongue 48 to prevent torque from being transferred to the tongue 48 when the post 46 rotates about the central axis 58. Generally, the thrust bearings 74 support an axial load relative to the central axis 58. Therefore, the tongue 48 may remain in a predetermined orientation while being moved linearly via the post 46 which allows the tongue 48 to align with the clevis 34, and more specifically, align with the slot 38 between the prongs 36. As such, little to no adjustment of the orientation of the tongue 48 is required to align the first opening 54 of the tongue 48 and the second opening 56 of the clevis 34 to accept the connector 52. The tongue 48 and thrust bearing 74 arrangement may be referred to as a roller 76 clutch.

The thrust bearings 74 may include a plurality of rollers 76 disposed between of a pair of rings 78. When torque is applied via rotation of the post 46, the rollers 76 spin to prevent torque transfer through the rings 78, and thus, prevents torque transfer to the tongue 48.

Continuing with FIGS. 5 and 6, the locking assembly 32 may include a plate 80 defining an aperture 82 along the central axis 58, and the tongue 48 may be attached to the plate 80. The tongue 48 may be attached to the plate 80 by any suitable fastening feature, and non-limiting examples of the fastening feature may include one or more of fasteners, adhesives, couplers, etc. For illustrative purposes, FIG. 5 illustrates fasteners attaching the plate 80 and the tongue 48 together.

The post 46 may be disposed through the aperture 82 of the plate 80. The plate 80 is sandwiched between a first one 84 of the thrust bearings 74 and a second one 86 of the thrust bearings 74. When torque is applied via rotation of the post 46, the thrust bearings 74 prevent torque transfer to the plate 80 of the tongue 48.

Referring to FIG. 6, the plate 80 has an inner surface 88 facing the central axis 58 to define a boundary of the aperture 82. The inner surface 88 of the plate 80 presents a smooth configuration. That is, the inner surface 88 of the plate 80 is not threaded. Therefore, the threads of the post 46 do not engage the plate 80, and thus, the post 46 bypasses engagement with the plate 80. As such, torque is not directly transferred to the plate 80 via the post 46.

Similarly, the thrust bearings 74 have an inner surface 90 facing the central axis 58 to define a boundary of an aperture 92. The inner surface 90 of the thrust bearings 74 presents a smooth configuration. That is, the inner surface 90 of the thrust bearings 74 are not threaded. Therefore, the threads of the post 46 do not engage the thrust bearings 74, and thus, the post 46 bypasses direct engagement with the thrust bearings 74.

Continuing with FIG. 5, the tongue 48 may define a cavity 94 open at an edge surface 96 of the tongue 48. The plate 80 is attached to the tongue 48 at the edge surface 96 to close the cavity 94. A portion of the post 46 and the first one 84 of the thrust bearings 74 or the second one 86 of the thrust bearings 74 are contained inside of the cavity 94. Generally, the cavity 94 and the tang 50 may oppose each other along the tongue 48 relative to the central axis 58.

Referring to FIGS. 5 and 6, the locking assembly 32 may include a plurality of first locking components 98 attached to the post 46 such that the plate 80 and the thrust bearings 74 are secured between the first locking components 98. The first locking components 98 sandwich together the thrust bearings 74 and the plate 80, and thus eliminates axial play between the post 46 and the tongue 48, and thus assists in maintaining the plate 80 and the tongue 48 in the desired orientation relative to the clevis 34. In certain configurations, the first locking components 98 are nuts threaded to the post 46.

Continuing with FIG. 6, the plate 80 may include a first surface 97 and a second surface 99 opposing the first surface 97. In certain configurations, the first surface 97 and the second surface 99 of the plate 80 are substantially parallel to each other. The first one 84 of the thrust bearings 74 is sandwiched between one of the first locking components 98 and the first surface 97 of the plate 80, and the second one 86 of the thrust bearings 74 is sandwiched between another one of the first locking component 98 and the second surface 99 of the plate 80. By having the first surface 97 of the plate 80 and the second surface 99 of the plate 80 being substantially parallel to each other, binding of the post 46 is prevented when the post 46 rotates.

Turning to FIGS. 1 and 5, the locking assembly 32 may include a second locking component 100 attached to the post 46 and engaging the bracket 20 to secure the post 46 relative to the bracket 20 in the final position. That is, when the desired position of the post 46 is obtained, the second locking component 100 is attached to the post 46 such that the second locking component 100 abuts the bracket 20, and more specifically, abuts a first side 102 of the flange 24 of the bracket 20, which locks the post 46 in the desired position. Generally, the first side 102 of the flange 24 faces the tongue 48. It is to be appreciated that in certain configurations, the second locking component 100 may abut a second side 104 of the flange 24 of the bracket 20 to lock the post 46 in the desired position. Generally, the second side 104 of the flange 24 faces the handle 66. In certain configurations, the second locking component 100 is a nut threaded to the post 46.

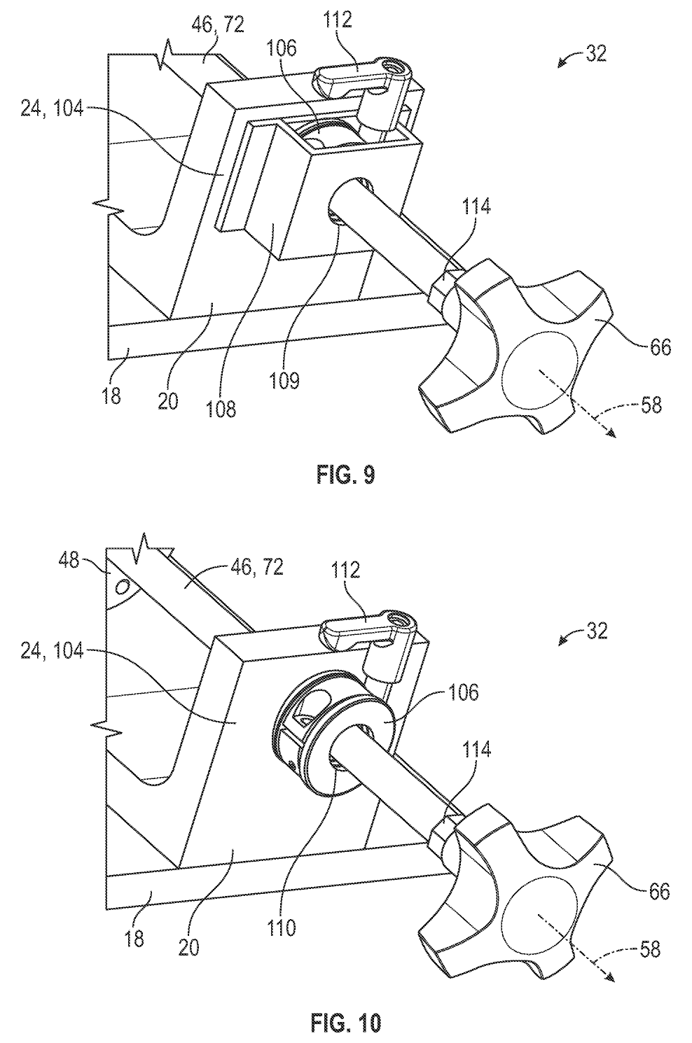

Referring to FIGS. 7-10, the locking assembly 32 may include one or more features 16, 30 of a different configuration than FIGS. 1, 2, 5, and 6. In the configuration of FIGS. 7-10, the post 46 may have an outer surface 72 that is smooth or flat, and thus, the post 46 may optionally eliminate the threads in this configuration. Similarly, the orifice 64 of the bracket 20 may eliminate the threads. As such, for the configuration, the post 46 may slide back and forth through the bracket 20 without being rotated since the threaded engagement has been eliminated.

As best shown in FIG. 8, the tongue 48 is fixed or attached to the post 46, and the thrust bearings 74 have been eliminated because torque has been eliminated since the post 46 is not required to rotate due to a threaded engagement. However, it is to be appreciated that the post 46 may rotate to align the tongue 48 in the desired orientation relative to the clevis 34, and more specifically, relative to the slot 38 between the prongs 36.

Continuing with the configuration of FIGS. 7-10, the locking assembly 32 may include a clamp 106 supported via the bracket 20. More specifically, the locking assembly 32 may include a band 108 or brace 108 that surrounds the clamp 106 to fix or attach the clamp 106 to the bracket 20, and thus, generally prevent separation of the clamp 106 from the bracket 20. The band 108 defines an aperture 109 along the central axis 58, and the post 46 is disposed through the aperture 109. The aperture 109 of the band 108 is larger than the outer surface 72 of the post 46 so that the post 46 moves freely through the band 108.

The clamp 106 may be movable between a locked position locking the post 46 in a fixed position and an unlocked position releasing the post 46 to allow linear movement of the post 46 relative to the central axis 58. The post 46 may be disposed through the clamp 106, and thus, the clamp 106 may define a through-hole 110 along the central axis 58 in which the post 46 is disposed through (and movable through) the through-hole 110. As such, the clamp 106 may include a lever 112 that is movable between the locked position and the unlocked position. When the lever 112 is moved in one direction, the clamp 106 may squeeze or apply a pressure to the post 46 to lock the post 46 in the fixed position. When the lever 112 is moved in another direction, different from the locked position direction, the clamp 106 releases the post 46 or removes the pressure from the post 46 in the unlocked position to allow movement of the post 46 relative to the central axis 58.

Turning back to FIGS. 1 and 5, the locking assembly 32 may include an alternative adjustment component 114 fixed to the handle 66, and/or fixed to the post 46. The alternative adjustment component 114 is configured to move the tongue 48 and the indexing assembly 28 linearly relative to the stationary support 18 when the tongue 48 is attached to the clevis 34. A tool may be used to engage the alternative adjustment component 114 to move the tongue 48 and corresponding indexing assembly 28 as desired instead of using the handle 66. In certain configurations, the alternative adjustment component 114 is a nut.

It is to be appreciated that more than one index tooling assembly 10 may be implemented, and thus, more than one indexing assembly 28, more than one locking assembly 32, and associated features 16, 30, including the brackets 20 and the rails 26, etc., depending on the type of component 12 being supported. For example, the component 12 may be supported as separate ends 68, 70, and thus one index tooling assembly 10 may be disposed at one end of the component 12 and another index tooling assembly 10 may be disposed at another end of the component 12, and so on depending on the desired number of locations to support the component 12.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration can be combined with one or a plurality of other desired characteristics from other configurations, resulting in other configurations not described in words or by reference to the drawings. Accordingly, such other configurations fall within the framework of the scope of the appended claims.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The illustrations of the configurations described herein are intended to provide a general understanding of the structure of the various configurations. The illustrations are not intended to serve as a complete description of all of the elements and features of apparatus and systems that utilize the structures or methods described herein. Many other configurations may be apparent to those of skill in the art upon reviewing the disclosure. Other configurations may be utilized and derived from the disclosure, such that structural and logical substitutions and changes may be made without departing from the scope of the disclosure. Accordingly, the disclosure and the figures are to be regarded as illustrative rather than restrictive.

The following Clauses provide some example configurations of the index tooling assembly 10 as disclosed herein.

Clause 1: An index tooling assembly for supporting a component during a manufacturing process, wherein the component includes a locating feature, the index tooling assembly comprising: a stationary support; a bracket fixed to the stationary support; a rail spaced from the bracket and fixed to the stationary support; an indexing assembly movably coupled to the rail to adjust a position of the indexing assembly relative to the stationary support; wherein the indexing assembly includes at least one indexing feature configured to cooperate with the locating feature of the component, and wherein the indexing assembly includes a clevis; and a locking assembly including a post movably coupled to the bracket and a tongue supported via the post and attachable to the clevis to move the indexing assembly linearly in response to movement of the post, and the post is selectively locked in a final position to fix the indexing assembly in an initial position to prevent movement of the indexing assembly relative to the stationary support.

Clause 2: The index tooling assembly as set forth in clause 1 wherein the indexing assembly is movable linearly relative to the rail in a first direction and a second direction opposite the first direction in response to movement of the post when the tongue is attached to the clevis.

Clause 3: The index tooling assembly as set forth in any one of the preceding clauses wherein: the bracket defines an orifice along a central axis; the post is disposed through the orifice; and the first direction and the second direction are substantially parallel to the central axis.

Clause 4: The index tooling assembly as set forth in any one of the preceding clauses wherein the indexing assembly includes a platform having the clevis and the at least one locating feature attached thereto.

Clause 5: The index tooling assembly as set forth in any one of the preceding clauses wherein the locking assembly includes a handle attached to a first end of the post and the tongue is attached to a second end of the post, wherein the post is supported via the bracket between the first end and the second end.

Clause 6: The index tooling assembly as set forth in any one of the preceding clauses wherein: the tongue defines a first opening and the clevis defines a second opening; and the locking assembly includes a connector selectively disposed through the first opening and the second opening to attach together the tongue and the clevis.

Clause 7: The index tooling assembly as set forth in any one of the preceding clauses wherein the first opening is defined along a first axis transverse to the central axis, and the first opening is elongated relative to opposing ends radially relative to the first axis such that the first opening forms an oblong orientation and is larger than the second opening.

Clause 8: The index tooling assembly as set forth in any one of the preceding clauses wherein the post is movable linearly relative to a central axis.

Clause 9: The index tooling assembly as set forth in any one of the preceding clauses wherein the locking assembly includes a clamp supported via the bracket, and the clamp is movable between a locked position locking the post in a fixed position and an unlocked position releasing the post to allow linear movement of the post relative to the central axis.

Clause 10: The index tooling assembly as set forth in any one of clauses 1-8wherein the post is threaded to the bracket such that rotation of the post about the central axis causes linear movement of the tongue relative to the central axis.

Clause 11: The index tooling assembly as set forth in any one of clauses 1-8 and 10 wherein the locking assembly includes a plurality of thrust bearings disposed about the post and coupled to the tongue to minimize rotation of the tongue when torque is applied to the thrust bearings via rotation of the post about the central axis.

Clause 12: The index tooling assembly as set forth in any one of clauses 1-8, 10, and 11 wherein: the locking assembly includes a plate defining an aperture along the central axis; the post is disposed through the aperture of the plate; and the plate is sandwiched between a first one of the thrust bearings and a second one of the thrust bearings.

Clause 13: The index tooling assembly as set forth in any one of clauses 1-8 and 10-12 wherein: the tongue is attached to the plate; the tongue defines a cavity open at an edge surface of the tongue; the plate is attached to the tongue at the edge surface to close the cavity; and a portion of the post and the first one of the thrust bearings or the second one of the thrust bearings are contained inside of the cavity.

Clause 14: The index tooling assembly as set forth in clause any one of clauses 1-8and 10-13 wherein the locking assembly includes a plurality of first locking components attached to the post such that the plate and the thrust bearings are secured between the first locking components.

Clause 15: The index tooling assembly as set forth in any one of clauses 1-8 and 10-14 wherein: the first locking components are nuts threaded to the post; the plate has an inner surface facing the central axis to define a boundary of the aperture; and the inner surface of the plate presents a smooth configuration.

Clause 16: The index tooling assembly as set forth in any one of clauses 1-8 and 10-15 wherein the locking assembly includes a second locking component attached to the post and engaging the bracket to secure the post relative to the bracket in the final position.

Clause 17: The index tooling assembly as set forth in any one of clauses 1-8 and 10-16 wherein the second locking component is a nut threaded to the post.

Clause 18: The index tooling assembly as set forth in any one of clauses 1-8and 10-17 wherein: the locking assembly includes a handle attached to a first end of the post and the tongue is attached to a second end of the post, wherein the first end and the second end are spaced from each other; and the locking assembly includes an alternative adjustment component fixed to the handle and configured to move the tongue and the indexing assembly linearly relative to the stationary support when the tongue is attached to the clevis.

Clause 19: The index tooling assembly as set forth in any one of clauses 1-8 and 10-18 wherein: the post is threaded and rotatable relative to a central axis; and the locking assembly includes a plurality of thrust bearings disposed between the post and the tongue to prevent torque from being transferred to the tongue when the post rotates about the central axis.

Clause 20: An index tooling assembly for supporting a component during a manufacturing process, wherein the component includes a locating feature, wherein a stationary support has a bracket and a rail fixed thereto, the index tooling assembly comprising: an indexing assembly configured to move linearly along the rail to adjust a position of the indexing assembly relative to the stationary support; wherein the indexing assembly includes at least one indexing feature configured to cooperate with the locating feature of the component, and wherein the indexing assembly includes a clevis; and a locking assembly including a post movably coupled to the bracket and a tongue supported via the post and attachable to the clevis to move the indexing assembly linearly in response to movement of the post, and the post is selectively locked in a final position to fix the indexing assembly in an initial position to prevent movement of the indexing assembly relative to the stationary support.

What is claimed is:

1. An index tooling assembly for supporting a component during a manufacturing process, wherein the component includes a locating feature, the index tooling assembly comprising:
a stationary support;
a bracket fixed to the stationary support;
a rail spaced from the bracket and fixed to the stationary support;
an indexing assembly movably coupled to the rail to adjust a position of the indexing assembly relative to the stationary support; wherein the indexing assembly includes at least one indexing feature configured to cooperate with the locating feature of the component, and wherein the indexing assembly includes a clevis; and
a locking assembly including a post movably coupled to the bracket and a tongue supported via the post and attachable to the clevis to move the indexing assembly linearly in response to movement of the post, and the post is selectively locked in a final position to fix the indexing assembly in an initial position to prevent movement of the indexing assembly relative to the stationary support.

2. The index tooling assembly as set forth in claim 1, wherein the indexing assembly is movable linearly relative to the rail in a first direction and a second direction opposite the first direction in response to movement of the post when the tongue is attached to the clevis.

3. The index tooling assembly as set forth in claim 2, wherein:
the bracket defines an orifice along a central axis;
the post is disposed through the orifice; and
the first direction and the second direction are substantially parallel to the central axis.

4. The index tooling assembly as set forth in claim 3, wherein the indexing assembly includes a platform having the clevis and the at least one locating feature attached thereto.

5. The index tooling assembly as set forth in claim 4, wherein the locking assembly includes a handle attached to a first end of the post and the tongue is attached to a second end of the post, wherein the post is supported via the bracket between the first end and the second end.

6. The index tooling assembly as set forth in claim 4, wherein:
the tongue defines a first opening and the clevis defines a second opening; and
the locking assembly includes a connector selectively disposed through the first opening and the second opening to attach together the tongue and the clevis.

7. The index tooling assembly as set forth in claim 6, wherein the first opening is defined along a first axis transverse to the central axis, and the first opening is elongated relative to opposing ends radially relative to the first axis such that the first opening forms an oblong orientation and is larger than the second opening.

8. The index tooling assembly as set forth in claim 1, wherein the post is movable linearly relative to a central axis.

9. The index tooling assembly as set forth in claim 8, wherein the locking assembly includes a clamp supported via the bracket, and the clamp is movable between a locked position locking the post in a fixed position and an unlocked position releasing the post to allow linear movement of the post relative to the central axis.

10. The index tooling assembly as set forth in claim 8, wherein the post is threaded to the bracket such that rotation of the post about the central axis causes linear movement of the tongue relative to the central axis.

11. The index tooling assembly as set forth in claim 10, wherein the locking assembly includes a plurality of thrust bearings disposed about the post and coupled to the tongue to minimize rotation of the tongue when torque is applied to the thrust bearings via rotation of the post about the central axis.

12. The index tooling assembly as set forth in claim 11, wherein:
the locking assembly includes a plate defining an aperture along the central axis;
the post is disposed through the aperture of the plate; and
the plate is sandwiched between a first one of the thrust bearings and a second one of the thrust bearings.

13. The index tooling assembly as set forth in claim 12, wherein:
the tongue is attached to the plate;
the tongue defines a cavity open at an edge surface of the tongue;
the plate is attached to the tongue at the edge surface to close the cavity; and
a portion of the post and the first one of the thrust bearings or the second one of the thrust bearings are contained inside of the cavity.

14. The index tooling assembly as set forth in claim 12, wherein the locking assembly includes a plurality of first locking components attached to the post such that the plate and the thrust bearings are secured between the first locking components.

15. The index tooling assembly as set forth in claim 14, wherein:
the first locking components are nuts threaded to the post;
the plate has an inner surface facing the central axis to define a boundary of the aperture; and
the inner surface of the plate presents a smooth configuration.

16. The index tooling assembly as set forth in claim 14, wherein the locking assembly includes a second locking component attached to the post and engaging the bracket to secure the post relative to the bracket in the final position.

17. The index tooling assembly as set forth in claim 16, wherein the second locking component is a nut threaded to the post.

18. The index tooling assembly as set forth in claim 17, wherein:
the locking assembly includes a handle attached to a first end of the post and the tongue is attached to a second end of the post, wherein the first end and the second end are spaced from each other; and
the locking assembly includes an alternative adjustment component fixed to the handle and configured to move the tongue and the indexing assembly linearly relative to the stationary support when the tongue is attached to the clevis.

19. The index tooling assembly as set forth in claim 1, wherein:
the post is threaded and rotatable relative to a central axis; and
the locking assembly includes a plurality of thrust bearings disposed between the post and the tongue to prevent torque from being transferred to the tongue when the post rotates about the central axis.

20. An index tooling assembly for supporting a component during a manufacturing process, wherein the component includes a locating feature, wherein a stationary support has a bracket and a rail fixed thereto, the index tooling assembly comprising:
an indexing assembly configured to move linearly along the rail to adjust a position of the indexing assembly relative to the stationary support; wherein the indexing assembly includes at least one indexing feature configured to cooperate with the locating feature of the component, and wherein the indexing assembly includes a clevis; and
a locking assembly including a post movably coupled to the bracket and a tongue supported via the post and attachable to the clevis to move the indexing assembly linearly in response to movement of the post, and the post is selectively locked in a final position to fix the indexing assembly in an initial position to prevent movement of the indexing assembly relative to the stationary support.
